(19) United States
(12) Patent Application Publication
(10) Pub. No.: US 2010/0089709 A1
(43) Pub. Date: Apr. 15, 2010

(54) VEHICLE BRAKE CONTROL APPARATUS

(76) Inventors: Michihito Shimada, Susono-shi (JP); Kazuya Maki, Nagoya-shi (JP)

Correspondence Address: KENYON & KENYON LLP, 1500 K STREET N.W., SUITE 700, WASHINGTON, DC, 20005, US

(21) Appl. No.: 12/525,623

(22) PCT Filed: Feb. 27, 2008
(86) PCT No.: PCT/JP2008/053426

§ 371 Date: Aug. 3, 2009

(30) Foreign Application Priority Data
Mar. 1, 2007 (JP) 2007-051955

(51) Int. Cl. B60L 7/10; B60T 13/18

(52) U.S. Cl. 188/159; 303/11

(57) ABSTRACT

A vehicle brake control apparatus is provided with a master cylinder capable of outputting master cylinder pressure, which is pressure of operating fluid generated by operation of a brake pedal, and hydraulic pumps capable of outputting pressurized pressure generated by pressurizing the operating fluid as braking force, wherein a brake ECU is configured to detect driver's requested braking force based on the master cylinder pressure to drive-control the hydraulic pumps based on the requested braking force, and when the hydraulic pumps outputs the braking force, the brake ECU changes the requested braking force according to a pedal stroke of the brake pedal at the time of the detection of the requested braking force, thereby enabling high-precision braking force control by setting optimal requested braking force always according to intension of a driver irrespective of a driving condition of the vehicle to improve drivability.

This is a 371 national phase application of PCT/JP2008/053426 filed 27 Feb. 2008, claiming priority to Japanese Patent Application No. 2007-051955 filed 1 Mar. 2007, the contents of which are incorporated herein by reference.

### FIELD OF THE INVENTION

The present invention relates to a vehicle brake control apparatus capable of outputting master cylinder pressure generated by operation of a brake pedal and pressurizing pressure generated by pressurizing operating oil as braking force, and especially relates to a vehicle brake control apparatus enabling collaborative control of a regenerative brake and a hydraulic brake in a vehicle capable of driving by using an electric motor as a power source.

### BACKGROUND OF THE INVENTION

Recently, a hybrid vehicle equipped with an engine for outputting a torque by burning of fuel and an electric motor for outputting the torque by supply of electricity and capable of driving by transmitting the torque of the engine and the electric motor to wheels is suggested. In such a hybrid vehicle, it is configured to drive the wheels only by the torque of the electric motor or to drive the wheels by the torque of the engine and of the electric motor by controlling driving and stopping of the engine and the electric motor according to a driving condition, and the electric motor can be driven by electricity stored in a battery, and when the energy of the battery decreases, the battery is charged by driving the engine.

That is to say, the hybrid vehicle is provided with the engine and the electric motor as a drive power source and with a planetary gear for combining the power of the engine and the electric motor to transmit to the wheels. Specifically, an output shaft of the engine is coupled to a carrier of the planetary gear, and an output shaft of the electric motor is coupled to a ring gear of the planetary gear, and it is configured such that the power is transmitted from a sprocket coupled to the ring gear to the wheels. Also, an electricity generator is provided between the planetary gear and the engine, and the rotating shaft of the electricity generator is coupled to a sun gear of the planetary gear. Therefore, the power of the engine is divided to the wheels and the electricity generator by the planetary gear, and by controlling a rotation speed of the electricity generator, the rotation speed of the engine can be controlled. That is to say, a power dividing mechanism composed of the planetary gear has a function to convert the rotation speed of the engine and a function to divide the power of the engine to the wheels and the electricity generator.

Then, in the hybrid vehicle, a regenerative braking system for converting kinetic energy of the vehicle to electric energy and retrieve the same in the battery to reuse, by allowing the electric motor to operate as the electricity generator when braking by an engine brake or when braking by a foot brake. Especially, an effect of energy retrieval is high in a driving pattern in which acceleration and deceleration are repeated, and when braking by the foot brake, the hydraulic brake and the regenerative brake are collaboratively controlled and the regenerative brake is preferentially used, and the energy retrieval is performed to lower vehicle speed.

Also, a brake control apparatus for electrically controlling the braking force of the brake apparatus, that is to say, the hydraulic pressure supplied to a wheel cylinder for driving the brake apparatus, with respect to a brake operation amount input from the brake pedal when the driver depresses the brake pedal is known. Such a brake control apparatus is disclosed, for example, in Patent Document 1.

The brake control apparatus disclosed in Patent Document 1 calculates a target value of brake liquid pressure to be applied to the wheel cylinder based on a pedal stroke and master cylinder pressure and controls the operation of a pressure increasing valve and a pressure decreasing valve, thereby controlling the brake liquid pressure of the wheel cylinder to be the target value.

Patent Document 1: Japanese Patent Application Laid-Open No. 2004-276666

### SUMMARY OF INVENTION

### Problem to be Solved by the Invention

In a hydraulic control line of the brake control apparatus in the conventional hybrid vehicle, an upstream control circuit for detecting a braking intension of the driver and a downstream control circuit for adjusting the hydraulic pressure are divided by a master cut valve. Therefore, when collaboratively controlling the hydraulic brake and the regenerative brake and preferentially using the regenerative brake, pressure adjustment by the downstream control circuit does not affect the upstream control circuit, so that the torque of the hydraulic brake can be freely controlled according to the regenerative torque. Although such a so-called brake-by-wire brake control apparatus is capable of high-precision collaborative control, there is a problem of being expensive.

On the other hand, although an in-line brake control apparatus in which the upstream control circuit for detecting the braking intension of the driver and the downstream control circuit for adjusting the hydraulic pressure are connected is not expensive, the operating oil is sucked from the master cylinder side in an early stage of pressurization of the operating oil by operation of the pump, so that the master cylinder pressure temporarily decreases and deceleration changes irrespective of the braking intension of the driver, and there is a problem that the drivability is deteriorated.

That is to say, from the braking state in which the driver's requested braking force is secured by the braking force by brake pedal force and the regenerative braking force, when the vehicle speed is decreased, the regenerative braking force gradually decreases, so that it is changed to secure the braking force by pressurizing the operating oil by operating the pump and secure the driver's requested braking force by the braking force by the brake pedal force and the braking force by the pump pressurization. However, when securing the braking force by pressurizing the operating oil by operating the pump, since the pump sucks the operating oil from the master cylinder side, the master cylinder pressure temporarily decreases. In general, the driver's requested braking force is set based on the master cylinder pressure and the brake apparatus generates the braking force by the pump pressurization based on the driver's requested braking force. Therefore, when the master cylinder pressure decreases, the driver's requested braking force is set to be low, so that sufficient braking force according to the intension of the driver cannot be secured.

The present invention is to solve such a problem, and an object of the present invention is to provide the vehicle brake control apparatus intended to improve drivability by enabling the high-precision braking force control by setting the optimal requested braking force always according to the intension of the driver irrespective of the driving condition of the vehicle.

### Means for Solving Problem

In order to solve the above mentioned problem and achieve the object, the vehicle brake control apparatus according to the present invention includes an operating member brake-operated by a driver; a master cylinder that causes master cylinder pressure being pressure of operating fluid generated by operation of the operating member to act on wheels as braking force; a pressurizing unit capable of outputting as braking force pressurized pressure generated by sucking the operating fluid from the master cylinder and pressurizing the sucked operating fluid irrespective of brake operation to the operating member; a requested braking force detecting unit that detects the driver's requested braking force based on the master cylinder pressure; and a braking force control unit that controls the pressurizing unit based on the requested braking force detected by the requested braking force detecting unit, an operation amount detecting unit that detects that a brake operation amount of the operating member is provided, wherein the requested braking force detecting unit changes the detected requested braking force to requested braking force based on the master cylinder pressure at the start of the suction by the pressurizing unit when an initial brake operation amount at the start of the suction of the operating fluid from the master cylinder by the pressurizing unit changes while the pressurizing unit causes the braking force to act on the wheels.

In the vehicle brake control apparatus according to the present invention, the requested braking force detecting unit may change the requested braking force based on the master cylinder pressure at the start of the suction by the pressurizing unit when a current brake operation amount detected by the operation amount detecting unit is between the initial brake operation amount and an estimated brake operation amount calculated based on current master cylinder pressure and current pressurized pressure.

In the vehicle brake control apparatus according to the present invention, the requested braking force detecting unit may change the requested braking force to requested braking force based on the current master cylinder pressure when the current brake operation amount detected by the operation amount detecting unit is smaller than the initial brake operation amount or larger than an estimated brake operation amount calculated based on the current master cylinder pressure and the current pressurized pressure.

In the vehicle brake control apparatus according to the present invention, the requested braking force detecting unit may calculate the driver's requested braking force while adding a pressure decrease gradient value or a pressure increase gradient value set in advance to the last master cylinder pressure.

The vehicle brake control apparatus according to the present invention further includes a regenerative braking force providing unit that causes regenerative braking force to act on the wheels, wherein the regenerative braking force providing unit may change the detected requested braking force when the regenerative braking force is switched to braking force acting on the wheels by the pressurizing unit.

### EFFECT OF THE INVENTION

A vehicle brake control apparatus according to the present invention is provided with a master cylinder for allowing master cylinder pressure, which is pressure of operating fluid generated by operation of an operating member, to act on wheels as braking force, pressurizing means capable of outputting pressurized pressure generated by sucking the operating fluid from the master cylinder and pressurizing the sucked operating fluid irrespective of brake operation to the operating member as braking force, requested braking force detecting means for detecting driver's requested braking force based on the master cylinder pressure, and braking force controlling means for controlling the pressurizing means based on the requested braking force, and when an initial brake operation amount at the start of the suction of the operating fluid from the master cylinder by the pressurizing means changes while the pressurizing means allows the braking force to act on the wheels, the requested braking force detecting means changes the detected requested braking force to requested braking force based on the master cylinder pressure at the start of the suction by the pressurizing means, so that optimal requested braking force always according to intension of a driver is set irrespective of a driving condition of the vehicle and high-precision braking force control becomes possible, and as a result, drivability can be improved.

### BRIEF DESCRIPTION OF DRAWINGS

FIG. 1 is a schematic configuration diagram showing a vehicle brake control apparatus according to one embodiment of the present invention.

FIG. 2 is a schematic configuration diagram showing a hybrid vehicle to which the vehicle brake control apparatus of this embodiment is applied.

FIG. 3 is a flowchart showing braking force control in the vehicle brake control apparatus of this embodiment.

FIG. 4 is a graph showing driver's requested braking force with respect to master cylinder pressure in the vehicle brake control apparatus of this embodiment.

FIG. 5 is a graph showing a brake pedal stroke with respect to wheel cylinder pressure in the vehicle brake control apparatus of this embodiment.

FIG. 6 is a graph showing braking force with respect to brake pedal force in the vehicle brake control apparatus of this embodiment.

FIG. 7 is a graph showing switching operation of the braking force in the vehicle brake control apparatus of this embodiment.

### EXPLANATIONS OF LETTERS OR NUMERALS

11 brake pedal (operating member)

12 brake booster

13 master cylinder

14 stroke sensor (operation amount detecting means)

18 master cylinder pressure sensor

19, 20 master cut valve

27FR, 27FL, 27RL, 27RR wheel cylinder

28, 29, 30, 31 electromagnetic holding valve

38, 39, 40, 41 electromagnetic pressure decreasing valve

51, 52 hydraulic pump (pressurizing means)

101 engine

102 electric motor

103 electricity generator

110 engine ECU

111 motor ECU

112 main ECU

114, 114FR, 114FL, 114RL, 114RR hydraulic brake device

115 hydraulic control device

116 brake ECU (requested braking force detecting means, braking force controlling means)

### DETAILED DESCRIPTION

Hereinafter, an embodiment of a vehicle brake control apparatus according to the present invention is described in detail with reference to the drawings. Meanwhile, this embodiment does not limit the present invention.

### Embodiment

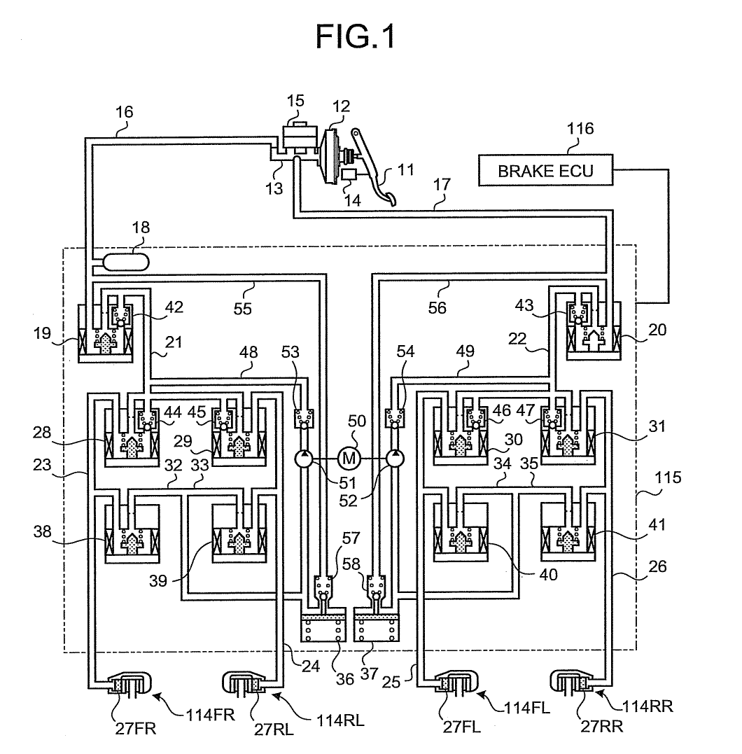

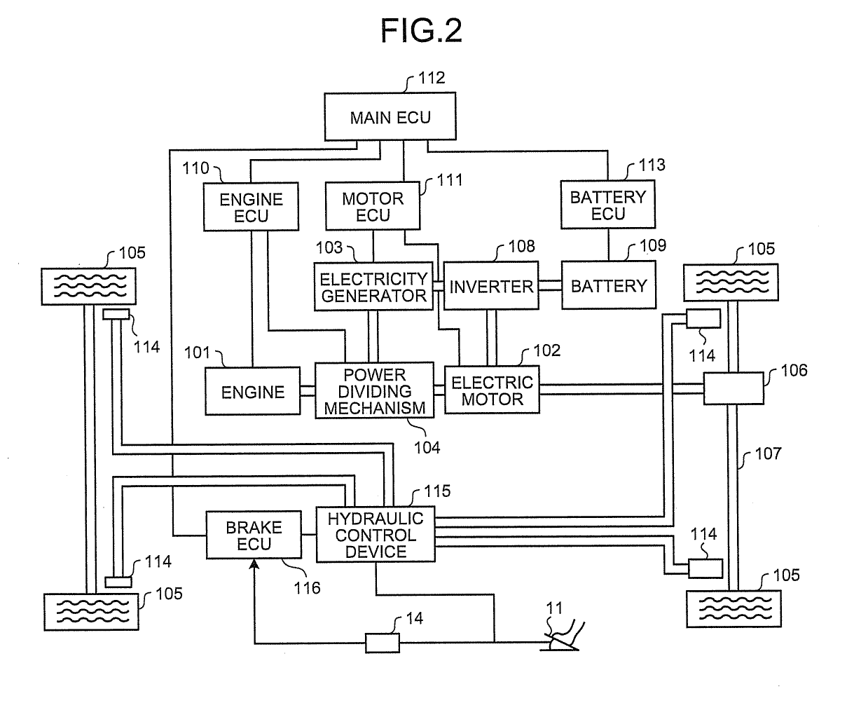

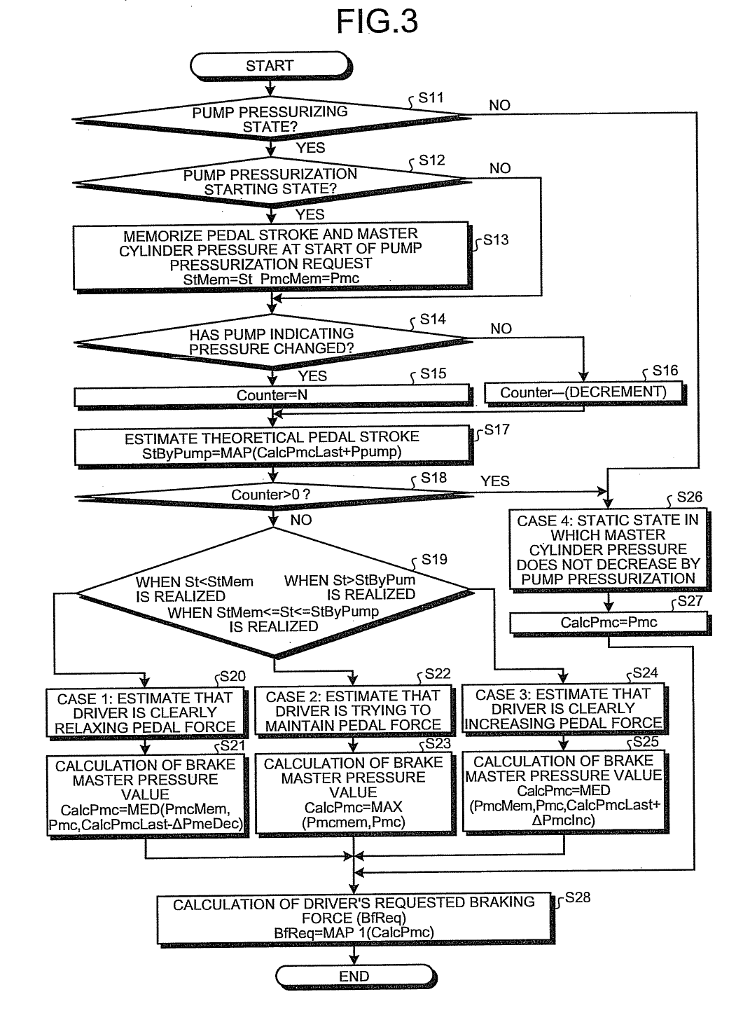

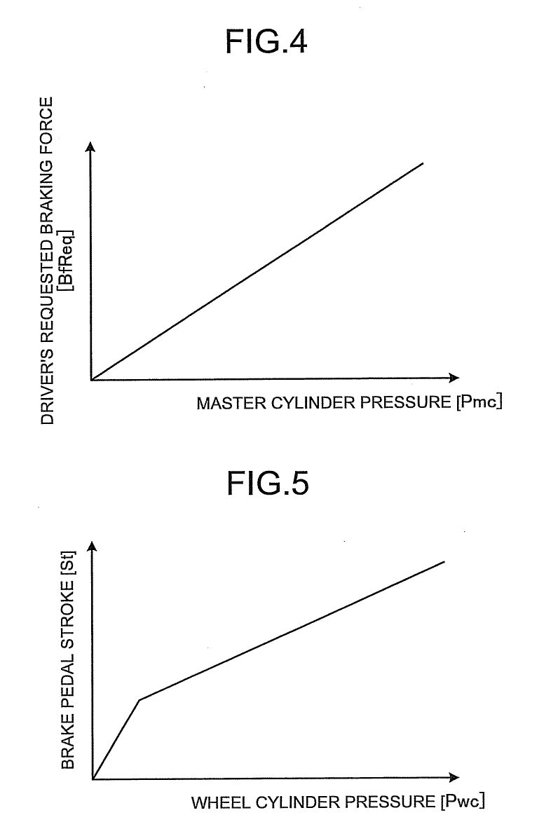

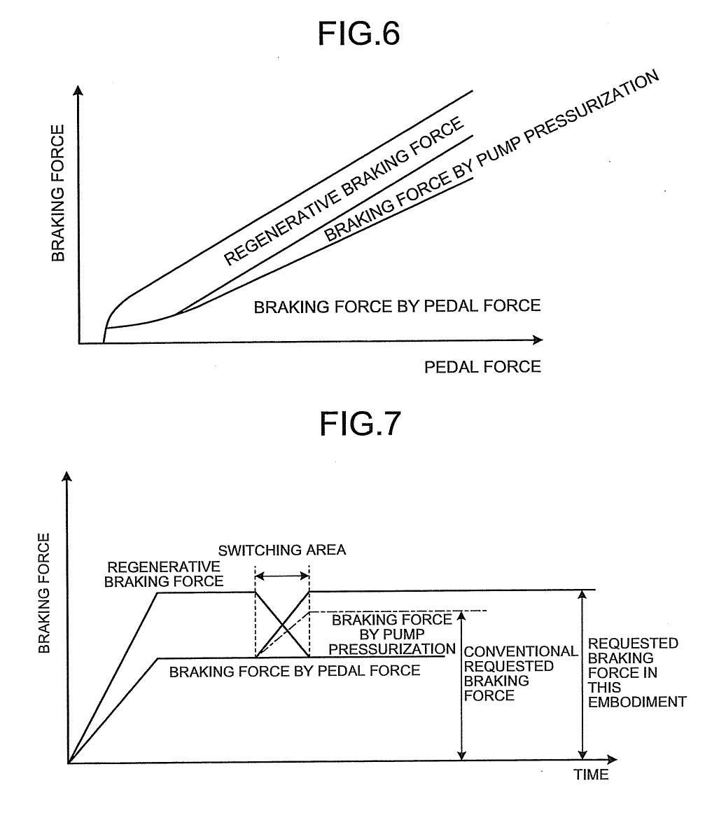

FIG. 1 is a schematic configuration diagram showing a vehicle brake control apparatus according to one embodiment of the present invention, FIG. 2 is a schematic configuration diagram showing a hybrid vehicle to which the vehicle brake control apparatus of this embodiment is applied, FIG. 3 is a flowchart showing braking force control in the vehicle brake control apparatus of this embodiment, FIG. 4 is a graph showing driver's requested braking force with respect to master cylinder pressure in the vehicle brake control apparatus of this embodiment, FIG. 5 is a graph showing a brake pedal stroke with respect to wheel cylinder pressure in the vehicle brake control apparatus of this embodiment, FIG. 6 is a graph showing braking force with respect to brake pedal force in the vehicle brake control apparatus of this embodiment, and FIG. 7 is a graph showing switching operation of the braking force in the vehicle brake control apparatus of this embodiment.

In the hybrid vehicle to which the vehicle brake control apparatus of a first embodiment is applied, as shown in FIG. 2, the vehicle is equipped with an engine 101 and an electric motor 102 as a power source, and the vehicle is equipped with an electricity generator 103 for generating electricity by receiving an output from the engine 101. The engine 101, the electric motor 102, and the electricity generator 103 are connected by a power dividing mechanism 104. The power dividing mechanism 104 allocates the output from the engine 101 to the electricity generator 103 and driving wheels 105 and transmits the output from the electric motor 102 to the driving wheels 105, and serves as a transmission regarding driving force transmitted to the driving wheels 105 through a reducer 106 and a driving shaft 107.

The electric motor 102 is an alternating-current synchronous electric motor and is driven by alternating-current power. An inverter 108 converts electricity stored in a battery 109 from direct current to alternating current and supplies the same to the electric motor 102, and converts the electricity generated by the electricity generator 103 from the alternating current to the direct current and stores the same in the battery 109. The electricity generator 103 also basically has a configuration substantially similar to that of the above-described electric motor 102, and has a configuration as the alternating-current synchronous electric motor. In this case, the electricity generator 103 mainly generates electricity by receiving the output from the engine 101, while the electric motor 102 mainly outputs the driving force.

In addition, although the electric motor 102 mainly generates the driving force, the electric motor 102 may generate electricity by using rotation of the driving wheels 105 (regenerative electric generation), and the electric motor 102 may also serve as the electricity generator. At that time, a regenerative brake acts on the driving wheels 105, so that it is possible to brake the vehicle by using the regenerative brake in combination with a foot brake and an engine brake. On the other hand, although the electricity generator 103 mainly generates electricity by receiving the output from the engine 101, the electricity generator 103 may serve as an electric motor receiving the electricity from the battery 109 through the inverter 108 to drive.

Meanwhile, the engine 101 is provided with a crank position sensor (not shown) for detecting a piston position and an engine rotational frequency to output a detection result to an engine ECU 110. Also, the electric motor 102 and the electricity generator 103 are provided with a rotational frequency sensor (not shown) for detecting a rotational position and a rotational frequency to output a detection result to a motor ECU 111.

The above-described various controls of the hybrid vehicle are controlled by a plurality of electric control unit (ECU). The drive by the engine 101 and the drive by the electric motor 102 characteristic as the hybrid vehicle are comprehensively controlled by the main ECU 112. That is to say, allocation of output from the engine 101 and the output from the electric motor 102 is determined by the main ECU 112, and various control commands are output to the engine ECU 110 and the motor ECU 111 so as to control the engine 101, the electric motor 102, and the electricity generator 103.

In addition, the engine ECU 110 and the motor ECU 111 output information of the engine 101, the electric motor 102, and the electricity generator 103 also to the main ECU 112. A battery ECU 113 for controlling the battery 109 also is connected to the main ECU 112. The battery ECU 113 monitors a charging state of the battery 109, and when an amount of charge runs short, the battery ECU 113 outputs a charge request command to the main ECU 112. The main ECU 112, which has received the charge request, performs control to allow the electricity generator 103 to generate electricity to charge the battery 109.

Also, the vehicle is provided with hydraulic brake devices 114 so as to correspond to the driving wheels 105, respectively. Adjusted braking hydraulic pressure is supplied from a hydraulic control device 115 to the hydraulic brake device 114. A brake ECU 116 for controlling the hydraulic control device 115 also is connected to the above-described main ECU 112. The brake ECU 116 detects the driver's requested braking force according to an operation amount of the brake pedal or liquid pressure of a master cylinder 13 obtained thereby and outputs the requested braking force to the main ECU 112. The main ECU 112 outputs the requested braking force to the motor ECU 111, and the motor ECU 111 controls the regenerative brake and outputs an execution value, that is to say, executed regenerating braking force to the main ECU 112. The main ECU 112 subtracts the regenerative braking force from the requested braking force to set requested hydraulic braking force, and the brake ECU 116 controls the hydraulic control device 115 based on the requested hydraulic braking force to operate the hydraulic brake device 114.

In the hybrid vehicle thus configured, the vehicle brake control apparatus of this embodiment is hereinafter described in detail.

In the vehicle brake control apparatus of this embodiment, as shown in FIG. 1, a brake booster 12 is connected to a brake pedal (operating member) 11, and the master cylinder 13 is fixed to the brake booster 12. In addition, a pedal stroke sensor (operation amount detecting means) 14 for detecting a depression amount, that is to say, a pedal stroke, is mounted on the brake pedal 11 to output a detection result to the brake ECU 116. The brake booster 12 can generate assist force having a predetermined magnification ratio with respect to a depressing operation of the brake pedal 11 by the driver. The master cylinder 13 has two hydraulic chambers not shown therein, and the master cylinder pressure obtained by combining the brake pedal force and the assist force is generated in each hydraulic chamber. A reservoir tank 15 is provided on an upper part of the master cylinder 13, and the master cylinder 13 and the reservoir tank 15 are brought into communication with each other when the depression on the brake pedal 11 is released.

Hydraulic supply paths 16 and 17 are connected to each of the hydraulic chambers of the master cylinder 13, respectively, the hydraulic supply path 16 is connected to a hydraulic control circuit on a front wheel side of the hydraulic control device 115 and the hydraulic supply path 17 is connected to the hydraulic control circuit on a rear wheel side of the hydraulic control device 115. Then, a master cylinder pressure sensor 18 for detecting supply hydraulic pressure is mounted on one hydraulic supply path 17 to output the detection result to the brake ECU 116.

Then, master cut valves 19 and 20 are mounted on the hydraulic supply paths 16 and 17, respectively, and the above-described master cylinder pressure sensor 18 is arranged between the master cylinder 13 and the master cut valve 19 on the hydraulic supply path 16. The master cut valves 19 and 20 are so-called normal open type flow regulating electromagnetic valves, and opening thereof can be controlled at the time of energization by the brake ECU 116.

A coupling path 21 is connected to the one hydraulic supply path 16 through the master cut valve 19, and a coupling path 22 is connected to the other hydraulic supply path 17 through the master cut valve 20. The one coupling path 21 is branched into two branch paths 23 and 24, and the other coupling path 22 is branched into two branch paths 25 and 26. The branch paths 23 and 24 are connected to wheel cylinders 27FR and 27RL for driving the hydraulic brake devices 114 (114FR, 114RL) arranged on each of the driving wheels 105 (refer to FIG. 2), respectively. Also, the branch paths 25 and 26 are connected to wheel cylinders 27FL and 27RR for driving the hydraulic brake devices 114 (114FL, 114RR) arranged on each of the driving wheels 105 (refer to FIG. 2), respectively. Meanwhile, although a hydraulic piping system is herein cross piping, this may be front and rear piping.

Electromagnetic holding valves 28, 29, 30 and 31 are arranged on the branch paths 23, 24, 25 and 26, respectively. Also, hydraulic discharge paths 32, 33, 34 and 35 are branched from the branch paths 23, 24, 25 and 26 at portions closer to the wheel cylinders 27FR, 27RL, 27FL and 27RR than the electromagnetic holding valves 28, 29, 30 and 31, respectively, and the hydraulic discharge paths 32 and 33 and the hydraulic discharge paths 34 and 35 are connected to auxiliary reservoirs 36 and 37, respectively. Also, electromagnetic pressure decreasing valves 38, 39, 40 and 41 are arranged on the hydraulic discharge paths 32, 33, 34 and 35, respectively.

The electromagnetic holding valves 28, 29, 30 and 31 are the so-called normal open type flow regulating magnetic valves, and opening thereof can be controlled at the time of energization by the brake ECU 116. Also, the electromagnetic pressure decreasing valves 38, 39, 40 and 41 are so-called normal close type flow regulating electromagnetic valves, and opening thereof can be controlled at the time of energization by the brake ECU 116.

Meanwhile, check valves 42 and 43 are provided in parallel with the master cut valves 19 and 20 between the hydraulic supply paths 16 and 17 and the coupling paths 21 and 22, respectively, to allow only flows of operating oil from sides of the hydraulic supply paths 16 and 17 to sides of the coupling paths 21 and 22. In addition, check valves 44, 45, 46 and 47 are provided on the branch paths 23, 24, 25 and 26 in parallel with the electromagnetic holding valves 28, 29, 30 and 31, respectively, to allow only flows of the operating oil from sides of the wheel cylinders 27FR, 27RL, 27FL and 27RR to sides of the master cut valves 19 and 20.

Pump paths 48 and 49 branched from the coupling paths 21 and 22 and connected to the auxiliary reservoirs 36 and 37, respectively, are provided, and hydraulic pumps (pressurizing means) 51 and 52 driven by a pump motor 50 are arranged in the middle of the pump paths 48 and 49, respectively, and check valves 53 and 54 are arranged on portions closer to the master cut valves 19 and 20 than the hydraulic pumps 51 and 52, respectively. Also, suction paths 55 and 56 branched from the hydraulic supply paths 16 and 17 and connected to the auxiliary reservoirs 36 and 37, respectively, are provided, and reservoir cut check valves 57 and 58 are arranged on sides of the auxiliary reservoirs 36 and 37 on the suction paths 55 and 56, respectively.

The brake ECU 116 is composed of a CPU, a memory, and the like, and performs brake control by executing a stored brake control program. That is to say, the pedal stroke detected by the pedal stroke sensor 14 and the master cylinder pressure detected by the master cylinder pressure sensor 18 are input to the brake ECU 116. Therefore, the brake ECU 116 controls the master cut valves 19 and 20, the electromagnetic holding valves 28, 29, 30 and 31, the electromagnetic pressure decreasing valves 38, 39, 40 and 41, and the pump motor 50 based on the pedal stroke and the master cylinder pressure, and can adjust the brake hydraulic pressure to the wheel cylinders 27FR, 27RL, 27FL and 27RR.

Therefore, in general, the master cut valves 19 and 20 are opened, the electromagnetic holding valves 28, 29, 30 and 31 are opened, and the electromagnetic pressure decreasing valves 38, 39, 40 and 41 are closed, and when the driver performs depression operation of the brake pedal 11, the brake booster 12 generates the assist force having the predetermined magnification ratio with respect to the depression operation, and the master cylinder 13 generates the master cylinder pressure obtained by combining the brake pedal force and the assist force.

The brake ECU 116 detects the driver's requested braking force based on the pedal stroke of the brake pedal 11 and outputs the requested braking force to the main ECU 112. The main ECU 112 outputs the requested braking force to the motor ECU 111, and the motor ECU 111 controls the regenerative brake and outputs the execution value, that is to say, the executed regenerative braking force to the main ECU 112. The main ECU 112 subtracts the regenerative braking force from the requested braking force to set the requested hydraulic braking force, and the brake ECU 116 controls the hydraulic control device 115 based on the requested hydraulic braking force.

Also, in a brake assist operation mode in a pressure increasing mode of the hydraulic brake device 114, while maintaining a state in which the master cut valve 19 and the electromagnetic holding valve 28 are opened and the electromagnetic pressure decreasing valve 38 is closed, the brake ECU 116 drive-controls the hydraulic pump 51 by the pump motor 50 and pressurizes the operating oil of the auxiliary reservoir 36, thereby pressurized pressure by the hydraulic pump 51 in addition to the master cylinder pressure generated by the master cylinder 13 circulate through the pump path 48, the coupling path 21, the master cut valve 19, the hydraulic supply path 16, and the auxiliary reservoir 36 and acts on the wheel cylinder 27FL through the electromagnetic holding valve 28 and the branch path 23, and the hydraulic pressure of the wheel cylinder 27FL increases to further strengthen the braking force.

By the way, the vehicle brake control apparatus according to this embodiment applied to the above-described hybrid vehicle detects the driver's requested braking force based on the pedal stroke of the brake pedal 11 and allocates the requested braking force to the regenerative braking force by the electric motor 102 and the requested hydraulic braking force by the hydraulic brake device 114. In this case, from a state in which the driver's requested braking force is secured by the regenerative braking force by the electric motor 102 and the hydraulic braking force by the hydraulic brake device 114, a vehicle speed decreases and the regenerative braking force gradually decreases, so that the brake ECU 116 pressurizes the operating oil by operating the hydraulic pumps 51 and 52 to raise the hydraulic braking force by the hydraulic brake device 114, and changes to secure the driver's requested braking force only by the requested hydraulic braking force by the hydraulic brake device 114, that is to say, by the braking force (master cylinder pressure) by the pedal force of the brake pedal 11 and the braking force by pressurization of the hydraulic pumps 51 and 52. However, since the hydraulic pumps 51 and 52 suck the operating oil from the master cylinder 13 side at that time, the master cylinder pressure temporarily decreases. Since the driver's requested braking force is set on the basis of the master cylinder pressure, when the master cylinder pressure decreases, the driver's requested braking force is set to be low, so that deceleration changes irrespective of the driver's braking request and drivability deteriorates.

Then, in the vehicle brake control apparatus of this embodiment, when an initial braking operation amount at the start of suction of the operating fluid from the master cylinder 13 by the hydraulic pumps 51 and 52 changes when the hydraulic pumps 51 and 52 allow the braking force to act on the driving wheels 105, the brake ECU 116 composing requested braking force detecting means and braking force controlling means of the present invention changes the detected requested braking force to the requested braking force based on the master cylinder pressure at the start of the suction by the hydraulic pumps 51 and 52, and controls the hydraulic control device 115 based on the changed requested braking force to operate the hydraulic brake device 114.

That is to say, when the pedal stroke of the brake pedal 11 detected by the stroke sensor 14 is between an initial pedal stroke and an estimated pedal stroke calculated based on current master cylinder pressure and current pressurized pressure of the hydraulic pumps 51 and 52, the brake ECU 116 changes to the requested braking force based on the master cylinder pressure at the start of the suction by the hydraulic pumps 51 and 52.

On the other hand, when the pedal stroke of the brake pedal 11 detected by the stroke sensor 14 is smaller than the initial pedal stroke, or larger than the estimated pedal stroke calculated based on the current master cylinder pressure and the current pressurized pressure of the hydraulic pumps 51 and 52, the requested braking force is changed to the requested braking force based on the master cylinder pressure. At that time, the brake ECU 116 calculates the driver's requested braking force while adding a pressure decrease gradient value or a pressure increase gradient value set in advance to the last master cylinder pressure.

Then, when the brake ECU 116 as regenerative braking force providing means for allowing the regenerative braking force to act on the driving wheels 105 is provided and the regenerative braking force is switched to the braking force acting on the driving wheels 105 by the hydraulic pumps 51 and 52, the detected requested braking force is changed.

Herein, braking force control when switching from the regenerative braking force by the electric motor 102 to the braking force by the pressurization of the hydraulic pumps 51 and 52 by the vehicle brake control apparatus of this embodiment is described in detail with reference to a flowchart in FIG. 3.

In the braking force control by the vehicle brake control apparatus of this embodiment, as shown in FIG. 3, at a step S11, the brake ECU 116 judges whether the hydraulic pumps 51 and 52 get into a pressurized state from a state in which the braking force is secured by the regenerative braking force by the electric motor 102 and the hydraulic braking force (master cylinder pressure) by the braking pedal force in the hydraulic brake device 114.

When it is judged that the hydraulic pumps 51 and 52 are not in the pressurized state at the step S11, the procedure shifts to a step S26, and it is defined to be in a static state (case 4) in which master cylinder pressure Pmc is not decreased by the hydraulic pumps 51 and 52, and at a step S27, the brake ECU 116 sets master cylinder pressure for calculating driver's requested braking force CalcPmc to the master cylinder pressure Pmc detected by the master cylinder pressure sensor 18. Then, at a step S28, the brake ECU 116 calculates driver's requested braking force BfReq based on a requested braking force map shown in FIG. 4.

On the other hand, when it is judged that the hydraulic pumps 51 and 52 get into the pressurized state at a step 511, the brake ECU 116 judges, at a step S12, whether it is a state in which pressurization of the operating oil by the hydraulic pumps 51 and 52 is started. Herein, when it is judged to be in the state in which the pressurization of the operating oil by the hydraulic pumps 51 and 52 is started, the brake ECU 116 memorizes a pedal stroke St of the brake pedal 11 detected by the stroke sensor 14 at the start of pressurization of the operating oil by the hydraulic pumps 51 and 52 as an initial pedal stroke StMem and memorizes the master cylinder pressure Pmc detected by the master cylinder pressure sensor 18 at that time as an initial master cylinder pressure PmcMem, at a step S13. On the other hand, when it is judged not to be the state in which the pressurization of the operating oil by the hydraulic pumps 51 and 52 is started at the step S12, the process at the step S13 is skipped.

At a step S14, the brake ECU 116 judges whether pump indicating pressure of the hydraulic pumps 51 and 52 has changed. Herein, when it is judged that the pump indicating pressure of the hydraulic pumps 51 and 52 changes, a counter value N is added at a step S15; on the other hand, when it is judged that the pump indicating pressure of the hydraulic pumps 51 and 52 does not change, the counter value N is subtracted at the step S16.

Then, at a step S17, the brake ECU 116 estimates a theoretical estimated pedal stroke. That is to say, when the hydraulic pumps 51 and 52 are operated to increase the pressurized pressure of the operating oil while the regenerative braking force decreases, since the hydraulic pumps 51 and 52 suck the operating oil from the master cylinder 13 side, the master cylinder pressure temporarily decreases, and relationship between the current master cylinder pressure and actual driver's requested braking force shifts, so that the theoretical estimated pedal stroke is calculated while adding the pressurized pressure of the hydraulic pumps 51 and 52 to the master cylinder pressure. Specifically, theoretical estimated pedal stroke StByPump is calculated based on a brake pedal stroke map in FIG. 5 by using wheel cylinder pressure Pwc obtained by adding the indicating pressure of the hydraulic pumps 51 and 52 to last master cylinder pressure for calculating driver's requested braking force CalcPmcLast.

At a step S18, it is judged whether the counter value N calculated at the steps S15 and S16 is larger than 0, that is to say, whether the indicating pressure of the hydraulic pumps 51 and 52 is not constant (in the static state). Herein, when it is judged that the counter value N is larger than 0, that is to say, that the indicating pressure of the hydraulic pumps 51 and 52 are not constant, the procedure shifts to a step S26 to perform the process similar to that described above. On the other hand, at the step S18, when it is judged that the counter value N converges to 0, that is to say, that the indicating pressure of the hydraulic pumps 51 and 52 are constant, the procedure shifts to a step S19 and a detecting method of the driver's requested braking force is herein selected.

When it is judged that a current pedal stroke St of the brake pedal 11 detected by the stroke sensor 14 is smaller than the initial pedal stroke StMem at the start of the output of the braking force by the hydraulic pumps 51 and 52 at the step S19, it is estimated at a step S20 that the driver clearly relaxing the force of the brake pedal 11 and the master cylinder pressure for calculating driver's requested braking force CalcPmc is calculated based on the following equation. Then, at a step S28, the driver's requested braking force BfReq is calculated based on the requested braking force map shown in FIG. 4.

CalcPmc=MED(PmcMem, Pmc, CalcPmcLast−ΔPmcDec)

Meanwhile, MED herein is a function to select an intermediate value out of three values in parenthesis and ΔPmcDec is a last pressure decrease gradient value, and the pressure decrease gradient value ΔPmcDec may be a guard value set in advance or variably set based on an amount of change of the pedal stroke of the brake pedal 11. As a result, the master cylinder pressure for calculating driver's requested braking force CalcPmc finally converges to the current master cylinder pressure Pmc.

On the other hand, when it is judged that the current pedal stroke St of the brake pedal 11 detected by the stroke sensor 14 is between the initial pedal stroke StMem at the start of the output of the braking force by the hydraulic pumps 51 and 52 and the theoretical estimated pedal stroke StByPump calculated based on the current master cylinder pressure Pmc and the current pump indicating pressure Ppump of the hydraulic pumps 51 and 52 at the step S19, it is estimated at a step S22 that the driver is trying to maintain the pedal force of the brake pedal 11, and at a step S23, the master cylinder pressure for calculating driver's requested braking force CalcPmc is calculated based on the following equation. Then, at the step S28, the driver's requested braking force BfReq is calculated based on the requested braking force map shown in FIG. 4.

CalcPmc=MAX(PmcMem, Pmc)

Meanwhile, MAX herein is a function to select the maximum value out of two values in parenthesis. As a result, when the master cylinder pressure Pmc decreases, the master cylinder pressure for calculating driver's requested braking force CalcPmc adopts the initial master cylinder pressure PmcMem and finally converges to the current master cylinder pressure Pmc.

Also, when it is judged that the current pedal stroke St of the brake pedal 11 detected by the stroke sensor 14 is larger than the theoretical estimated pedal stroke StByPum calculated based on the current master cylinder pressure Pmc and the current pump indicating pressure Ppump of the hydraulic pumps 51 and 52 at the step S19, it is estimated, at a step S24, that the driver is clearly increasing the pedal force of the brake pedal 11, and the master cylinder pressure for calculating driver's requested braking force CalcPmc is calculated based on the following equation at a step S25. Then, at the step S28, the driver's requested braking force BfReq is calculated based on the requested braking force map shown in FIG. 4.

CalcPmc=MED(PmcMem, Pmc, CalcPmcLast+ΔPmcInc)

Meanwhile, MED herein is a function to select the intermediate value out of three values in parenthesis, ΔPmcInc is a last pressure increase gradient value, and the pressure increase gradient value ΔPmcInc may be the guard value set in advance or variably set based on the amount of change of the pedal stroke of the brake pedal 11. As a result, the master cylinder pressure for calculating driver's requested braking force CalcPmc finally converges to the current master cylinder pressure Pmc.

Therefore, in the vehicle brake control apparatus of this embodiment, as described above, when the hydraulic pumps 51 and 52 output the braking force, the requested braking force is changed according to the pedal stroke detected by the stroke sensor 14 at the time of detection of the requested braking force. That is to say, as shown in FIG. 6, when the braking force of the vehicle increases according to increase in the pedal force of the brake pedal 11 at the time of regenerative braking of the hybrid vehicle, although the braking force generated by the pedal force and the braking force generated by the pump pressurization also increase, the braking force by regeneration of the electric motor 102 is constant.

Then, as shown in FIG. 7, from a state in which the braking force of the vehicle is secured by the regenerative braking force by the electric motor 102 and the braking force (master cylinder pressure) by the pedal force in the hydraulic brake device 114, when the regenerative braking force decreases, the braking force is secured by pressurizing the operating oil by operating the hydraulic pumps 51 and 52 to switch the regenerative braking force to the braking force by the pump pressurization. In a switching area, although the master cylinder pressure decreases by pressurizing the operating oil by the hydraulic pumps 51 and 52, the requested braking force is conventionally obtained based on the decreased master cylinder pressure, so that the braking force by the pump pressurization decreases and the requested braking force intended by the driver decreases.

On the other hand, in this embodiment, although the master cylinder pressure decreases by pressuring the operating oil by the hydraulic pumps 51 and 52 in the switching area of the braking force, the driver's requested braking force is obtained based on the master cylinder pressure at the start of the output of the braking force by the hydraulic pumps 51 and 52, so that an appropriate requested braking force intended by the driver can be obtained.

In this manner, the vehicle brake control apparatus of this embodiment is provided with the master cylinder 13 capable of outputting the master cylinder pressure, which is the pressure of the operating fluid generated by the operation of the brake pedal 11, as the braking force, and the hydraulic pumps 51 and 52 capable of outputting the pressurized pressure generated by pressurizing the operating fluid as the braking force, the brake ECU 116 is configured to detect the driver's requested braking force based on the master cylinder pressure and drive-control the hydraulic pumps 51 and 52 based on the requested braking force, and the brake ECU 116 changes the requested braking force according to the pedal stroke of the brake pedal 11 at the time of detection of the requested braking force when the hydraulic pumps 51 and 52 output the braking force.

Therefore, optimal requested braking force always according to the intention of the driver is set irrespective of a running condition of the hybrid vehicle, thereby high-precision braking force control becomes possible, and as a result, the drivability can be improved.

Specifically, from a state in which the braking force of the hybrid vehicle is secured by the regenerative braking force by the electric motor 102 and the braking force (master cylinder pressure) by the pedal force in the hydraulic brake device 114, when the regenerative braking force decreases and the regenerative braking force is switched to the braking force by the pump pressurization such that the braking force is secured by pressuring the operating oil by operating the hydraulic pumps 51 and 52, when the current pedal stroke St of the brake pedal 11 is smaller than the initial pedal stroke StMem at the start of the output of the braking force by the hydraulic pumps 51 and 52, it can be estimated that the driver is relaxing the force of the brake pedal 11, so that the driver's requested braking force BfReq is calculated based on the current master cylinder pressure Pmc.

On the other hand, when the current pedal stroke St of the brake pedal 11 is between the initial pedal stroke StMem at the start of the output of the braking force by the hydraulic pumps 51 and 52 and the theoretical estimated pedal stroke StByPump calculated based on the current master cylinder pressure Pmc and the current pump indicating pressure Ppump of the hydraulic pumps 51 and 52, it can be estimated that the driver is trying to maintain the pedal force of the brake pedal 11, so that the driver's requested braking force BfReq is calculated based on the initial master cylinder pressure PmcMem.

Also, when the current pedal stroke St of the brake pedal 11 is larger than the theoretical estimated pedal stroke StByPump calculated based on the current master cylinder pressure Pmc and the current pump indicating pressure Ppump of the hydraulic pumps 51 and 52, it can be estimated that the driver is increasing the pedal force of the brake pedal 11, so that the driver's requested braking force BfReq is calculated based on the current master cylinder pressure Pmc.

In this manner, when the current pedal stroke St is between the initial pedal stroke StMem and the estimated pedal stroke StByPump, the pedal stroke hardly changes, and it can be considered that the driver wants to maintain the current braking force, so that the requested braking force BfReq is calculated by using the initial master cylinder pressure PmcMem so as not to change the requested braking force. On the other hand, when the current pedal stroke St is smaller than the initial pedal stroke StMem or larger than the estimated pedal stroke StByPump, the pedal stroke changes and it can be considered that the driver wants to decrease or increase the braking force, so that the requested braking force BfReq is calculated based on the current master cylinder pressure Pmc, which takes a return amount and a force increase amount of the brake pedal 11 into account.

Therefore, while operating the hydraulic brake device 114, when the regenerative braking force is switched to the braking force by the pump pressurization, it is possible to set the appropriate driver's requested braking force according to the current pedal stroke irrespective of decrease in master cylinder pressure, thereby enabling high-precision braking force control.

Also, when the current pedal stroke St is smaller than the initial pedal stroke StMem or larger than the estimated pedal stroke StByPump, the requested braking force BfReq is calculated based on the current master cylinder pressure Pmc, and at that time, the driver's requested braking force is calculated while adding the pressure decrease gradient value or the pressure increase gradient value set in advance to the last master cylinder pressure. Therefore, the high-precision driver's requested braking force can be set by taking disturbance due to increase in pressure of the operating oil by the hydraulic pumps 51 and 52 into account.

### INDUSTRIAL APPLICABILITY

As described above, the vehicle brake control apparatus according to the present invention is to improve the drivability by enabling the high-precision braking force control by setting the optimal requested braking force always according to the intension of the driver irrespective of the running condition of the vehicle, and is preferably used in any kind of brake control apparatus.

1. A vehicle brake control apparatus, comprising:
an operating member brake-operated by a driver;
a master cylinder that causes master cylinder pressure being pressure of operating fluid generated by operation of the operating member to act on wheels as braking force;
a pressurizing unit capable of outputting as braking force pressurized pressure generated by sucking the operating fluid from the master cylinder and pressurizing the sucked operating fluid irrespective of brake operation to the operating member;
a requested braking force detecting unit that detects the driver's requested braking force based on the master cylinder pressure; and
a braking force control unit that controls the pressurizing unit based on the requested braking force detected by the requested braking force detecting unit,
an operation amount detecting unit that detects that a brake operation amount of the operating member is provided, and
the requested braking force detecting unit changes the detected requested braking force to requested braking force based on the master cylinder pressure at the start of the suction by the pressurizing unit when an initial brake operation amount at the start of the suction of the operating fluid from the master cylinder by the pressurizing unit changes while the pressurizing unit allows the braking force to act on the wheels.

2. The vehicle brake control apparatus according to claim 1, wherein the requested braking force detecting unit changes to the requested braking force based on the master cylinder pressure at the start of the suction by the pressurizing unit when a current brake operation amount detected by the operation amount detecting unit is between the initial brake operation amount and an estimated brake operation amount calculated based on current master cylinder pressure and current pressurized pressure.

3. The vehicle brake control apparatus according to claim 1, wherein the requested braking force detecting unit changes the requested braking force to requested braking force based on the current master cylinder pressure when the current brake operation amount detected by the operation amount detecting unit is smaller than the initial brake operation amount or larger than an estimated brake operation amount calculated based on the current master cylinder pressure and the current pressurized pressure.

4. The vehicle brake control apparatus according to claim 3, wherein the requested braking force detecting unit calculates the driver's requested braking force while adding a pressure decrease gradient value or a pressure increase gradient value set in advance to the last master cylinder pressure.

5. The vehicle brake control apparatus according to claim 1, further comprising a regenerative braking force providing unit that causes regenerative braking force to act on the wheels, wherein the regenerative braking force providing unit changes the detected requested braking force when the regenerative braking force is switched to braking force acting on the wheels by the pressurizing unit.
